(19) United States
(12) Patent Application Publication
(10) Pub. No.: US 2014/0039867 A1
(43) Pub. Date: Feb. 6, 2014

(54) INFORMATION PROCESSING APPARATUS AND METHOD THEREOF

(71) Applicant: CANON KABUSHIKI KAISHA, Tokyo (JP)

(72) Inventors: Munetaka Higashidani, Kawasaki-shi (JP); Hiroyuki Takahashi, Tokyo (JP)

(21) Appl. No.: 13/922,737

(22) Filed: Jun. 20, 2013

(30) Foreign Application Priority Data
Jul. 31, 2012 (JP) 2012-170380

(51) Int. Cl. G06F 17/50

(52) U.S. Cl. CPC G06F 17/5022
USPC 703/21

(57) ABSTRACT

An information processing apparatus includes simulators which are configured to be directly or indirectly cooperated. A storage unit stores simulator operation scenarios having time information. A scenario execution unit extracts an elemental scenario as an element of a simulator operation scenario from the simulator operation scenario, transmits the elemental scenario to at least one of the simulators which are cooperated, synchronizes the simulators, and controls the simulators to execute simulator operations.

### BACKGROUND OF THE INVENTION

1. Field of the Invention

The present invention relates to information processing for controlling a plurality of simulators to cooperate with each other.

2. Description of the Related Art

In causal analysis of malfunctions of products which do not operate as they are assumed (to be referred to as “failure analysis” hereinafter) in product developments, a method of outputting an operation result of an existing equipment and executing failure analysis based on that output is generally used. However, there is information such as an LSI (Large Scale Integration) internal signal, which hardly outputs an operation result of an existing equipment, and failure analysis is often difficult to attain. Also, when mechanical components having various parameters are prepared, and an operation of an existing equipment is to be verified, much verification time and monetary cost are required.

For this reason, it is a common practice to use, in product development, a simulation technique which can relatively easily extract information and easily change parameters of product elements such as characteristics of mechanical components. In the simulation technique, since various parameters can be relatively easily changed, failure analysis can be executed by setting various parameters.

Japanese Patent Laid-Open No. 2011-107962 (literature 1) describes a simulation apparatus which controls a plurality of different simulators to cooperate with each other. In this apparatus, simulators of a mechanical mechanism, electric circuit, and software operate in cooperation with each other.

However, with the technique of literature 1, in order to analyze a phenomenon to be verified (for example, a malfunction phenomenon which occurred in experiments using an existing equipment), a result which caused the corresponding phenomenon has to be extracted from a simulation execution result, and has to be analyzed. For this reason, in order to obtain a result corresponding to the phenomenon to be analyzed, simulations under various conditions are often required. In such case, much simulation execution time and execution result selection time are required.

Japanese Patent Laid-Open No. 9-081600 (literature 2) describes a method of externally inputting an operation scenario to a simulator, and controlling to forcibly operate the simulator according to that operation scenario. For example, an operation scenario is input to a simulator of a mechanical mechanism (to be referred to as “mechanical simulator” hereinafter), and the mechanical simulator is operated according to that operation scenario, thus verifying the operation of the mechanical mechanism.

Literature 2 discloses a sole simulator such as a mechanical simulator or electric circuit simulator. However, in order to simulate a whole real product, for example, an integrated simulator which controls a mechanical simulator, electric circuit simulator, and software simulator to cooperate with each other is required. Therefore, when operation scenarios are externally input to respective sole simulators disclosed in literature 2, and these simulators are synchronously operated, much time is required to build a simulator execution environment.

Of course, there are a variety of combination patterns of simulators depending on product arrangements, and a simulator execution environment has to be built every time a different combination pattern is used.

In this manner, when analysis is executed for a specific phenomenon using simulators, simulations have to be executed under various conditions, and the specific phenomenon has to be selected from these simulation results. In case of a sole simulator, it is general and easy to execute a simulation based on an externally input operation scenario. However, it is not easy to control to operate an integrated simulator based on operation scenarios.

### SUMMARY OF THE INVENTION

In one aspect, an information processing apparatus comprising: a plurality of simulators which are configured to be directly or indirectly cooperated; a storage unit configured to store simulator operation scenarios having time information; and an execution unit configured to extract an elemental scenario as an element of the simulator operation scenario from the simulator operation scenario, to transmit the elemental scenario to at least one of the plurality of simulators which are cooperated, to synchronize the plurality of simulators, and to control the plurality of simulators to execute simulator operations.

According to the aspect, a plurality of simulators which can cooperate directly or indirectly can be controlled to execute simulator operations based on a simulator operation scenario.

Further features of the present invention will become apparent from the following description of exemplary embodiments with reference to the attached drawings.

### BRIEF DESCRIPTION OF THE DRAWINGS

FIG. 1 is a block diagram for explaining the processing arrangement of a simulation apparatus according to the first embodiment.

FIG. 2 is a view for explaining an example of a simulator operation scenario.

FIG. 3 is a flowchart for explaining the operation of the simulation apparatus.

FIG. 4 is a view showing an example of a UI used to select a simulator operation scenario.

FIG. 5 is a block diagram for explaining the arrangement of a scenario execution unit.

FIGS. 6A and 6B are flowcharts for explaining the operation of the scenario execution unit.

FIG. 7 is a view showing an example of a UI used to input an arithmetic processing method.

FIG. 8 is a view for explaining a detailed setting example of the arithmetic processing method.

FIG. 9 is a view for explaining a display example of a change rate and the like.

FIGS. 10A and 10B are views for explaining display examples of timing charts in a factorial analysis method of a genesis phenomenon using timing charts.

FIG. 11 is a view showing a display example which cooperates a change rate calculation result and display of timing charts.

FIG. 12 is a view for explaining a display example of a histogram in a factorial analysis method of a genesis phenomenon using a histogram.

FIG. 13 is a block diagram showing the processing arrangement of a simulation apparatus according to the second embodiment.

FIG. 14 is a block diagram for explaining the arrangement of a scenario execution unit according to the second embodiment.

FIG. 15 is a block diagram showing the processing arrangement of a simulation apparatus according to the third embodiment.

FIG. 16 is a block diagram showing the processing arrangement of a simulation apparatus according to the fourth embodiment.

### DESCRIPTION OF THE EMBODIMENTS

An information processing apparatus which executes simulations according to embodiments of the present invention (to be referred to as “simulation apparatus” hereinafter) and its information processing will be described in detail hereinafter with reference to the drawings.

### First Embodiment

[Arrangement of Apparatus]

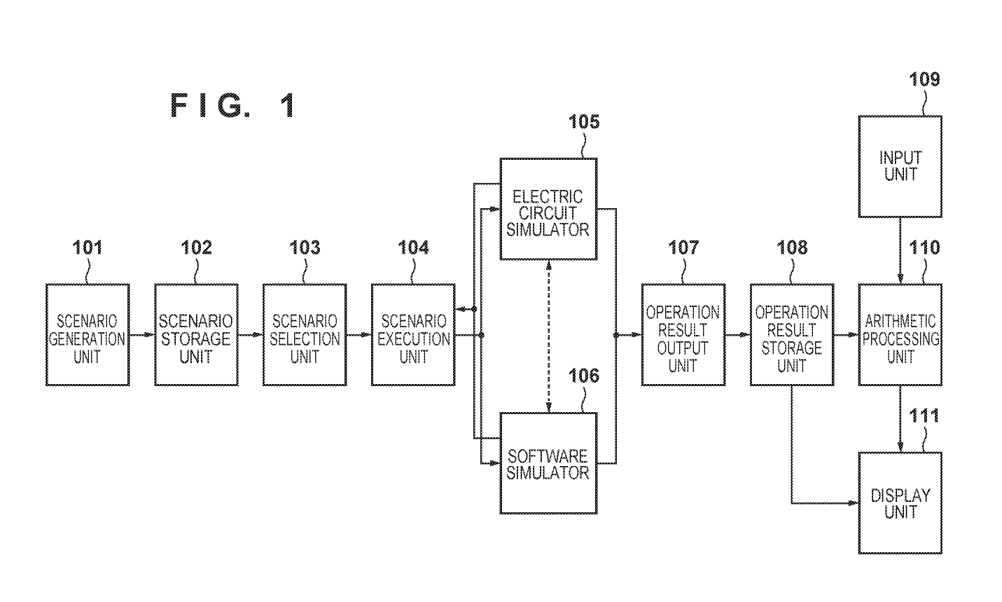

The processing arrangement of a simulation apparatus according to the first embodiment will be described below with reference to the block diagram shown in FIG. 1. Note that the processing arrangement shown in FIG. 1 is implemented when a simulation program is supplied to a computer, and the computer executes the program.

Simulator

The simulation apparatus includes a plurality of simulators.

An electric circuit simulator 105 is used to simulate an electric circuit. For example, a simulator which simulates an operation of an ASIC (Application Specific Integrated Circuit) as one of electronic components and an operation of an electric circuit on an entire circuit board using software is known. The electric circuit simulator 105 includes an emulator which implements some or all components of an electric circuit by an electric circuit such as an FPGA (Field Programmable Gate Array). That is, the electric circuit simulator 105 may include a simulator as a combination of a simulator, which simulates an electric circuit using software, and an emulator.

A software simulator 106 is used to simulate an operation of software. For example, a simulator such as an ISS (Instruction Set Simulator), which simulates instruction operations of a microprocessor (CPU) using software, is known. Also, the software simulator 106 may include a simulator using a modeling language such as a UML (Unified Modeling Language).

However, the electric circuit simulator 105 and software simulator 106 in this embodiment are not limited to the aforementioned simulator examples.

The electric circuit simulator 105 and software simulator 106 cooperate with each other by exchanging signals. That is, the operation of the electric circuit simulator 105 is influenced by the operation result of the software simulator 106, and vice versa. FIG. 1 describes an arrangement in which the electric circuit simulator 105 and software simulator 106 are connected via a broken line to directly communicate and cooperate with each other. However, an arrangement for managing a cooperation, for example, a cooperation management unit by means of a program which implements a cooperation management function, can be arranged between simulators, and the simulators can be controlled to indirectly cooperate with each other via the cooperation management unit.

Arrangement Associated with Operation Scenario

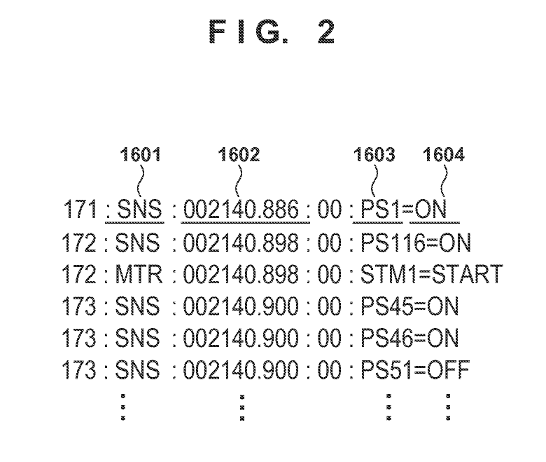

A scenario required to operate a simulator (to be referred to as “simulator operation scenario” hereinafter) has at least time information and information indicating a signal change. An example of a simulator operation scenario will be described below with reference to FIG. 2. Referring to FIG. 2, a column 1601 indicates a signal type of a sensor, motor, or the like, a column 1602 indicates a time (an elapsed time since the beginning of a simulation), a column 1603 indicates a signal name, and a column 1604 indicates a signal change.

Referring to FIG. 1, a scenario generation unit 101 generates a simulator operation scenario, and stores the generated simulator operation scenario in a scenario storage unit 102. A scenario selection unit 103 selects a simulator operation scenario stored in the scenario storage unit 102, and supplies the selected simulator operation scenario to a scenario execution unit 104 which controls to synchronously operate simulators.

Note that a simulator operation scenario, which is generated by the scenario generation unit 101 based on an operation log of an existing equipment, and that which is generated in advance may be held in the scenario storage unit 102. Also, the scenario generation unit 101 may include a user interface, and may generate a simulator operation scenario according to a user instruction.

Arrangement Associated with Simulator Operation Result

An operation result output unit 107 stores one or both of operation results of the electric circuit simulator 105 and software simulator 106 in an operation result storage unit 108. An input unit 109 includes a UI (User Interface) displayed on a monitor (not shown), a keyboard, a pointing device, and the like, and is used to input an arithmetic processing method required to analyze factors of a phenomenon using the simulator operation results. Note that to analyze factors of a genesis phenomenon will often be referred to as “factorial analysis of a genesis phenomenon” hereinafter.

An arithmetic processing unit 110 applies arithmetic processing to the simulator operation results stored in the operation result storage unit 108 according to the arithmetic processing method input by the input unit 109. A display unit 111 displays the UI, the simulator operation results stored in the operation result storage unit 108, the arithmetic processing results of the arithmetic processing unit 110, and the like on a monitor (not shown) or the like.

[Operation of Apparatus]

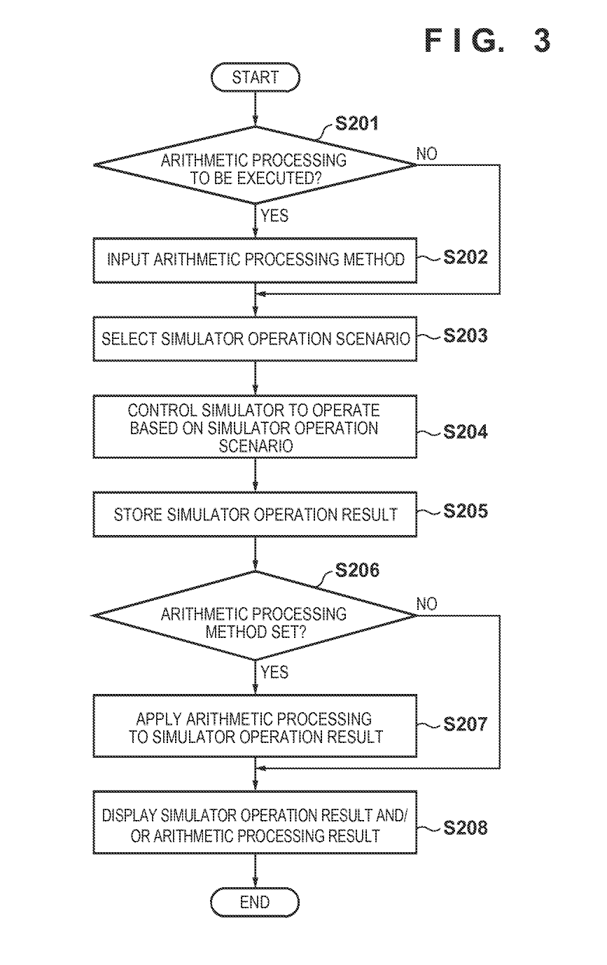

The operation of the simulation apparatus will be described below with reference to the flowchart shown in FIG. 3.

It is determined whether or not arithmetic processing is to be executed (S201). If the arithmetic processing is to be executed, an arithmetic processing method is input using the input unit 109 (S202). Details of an input operation of the arithmetic processing method will be described later.

Next, the scenario selection unit 103 selects a simulator operation scenario, and inputs the selected simulator operation scenario to the scenario execution unit 104 (S203). The user selects an arbitrary simulator operation scenario stored in the scenario storage unit 102, and controls the simulation apparatus to operate according to the selected simulator operation scenario, thus allowing simulation of only a phenomenon to be reproduced.

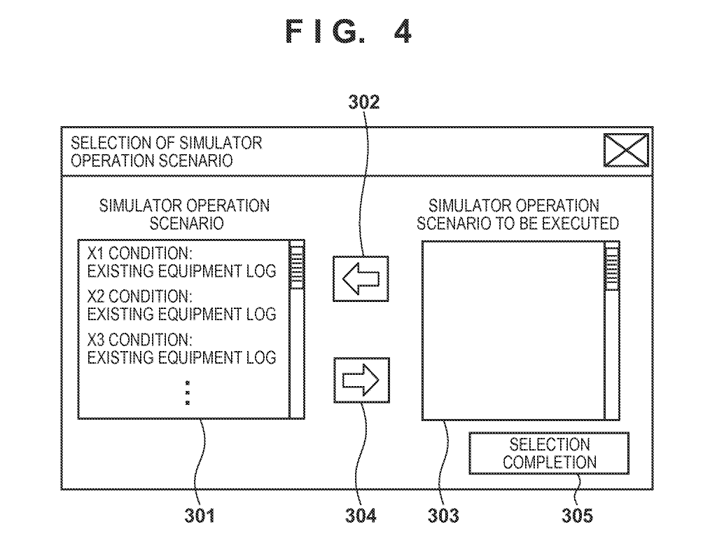

FIG. 4 shows an example of a UI used to select a simulator operation scenario. A list box 301 lists simulator operation scenarios stored in the scenario storage unit 102. The user selects a simulator operation scenario in the list box 301, and presses an add button 304 to add the selected simulator operation scenario to a list box 303.

The list box 303 displays a list of simulator operation scenarios which are decided to be input to simulators. When the user wants to delete a simulator operation scenario from the list box 303, he or she selects a corresponding simulator operation scenario, and presses a delete button 302. Upon completion of selection of simulator operation scenarios to be input to simulators, the user presses a selection completion button 305.

Upon pressing of the selection completion button 305, the scenario execution unit 104 controls the electric circuit simulator 105 and software simulator 106 while synchronizing these simulators with each other based on the selected simulator operation scenario (S204). Note that details of the operations of the simulators will be described later.

Upon completion of the operations of the simulators, the operation result output unit 107 stores the simulator operation results in the operation result storage unit 108 (S205). Next, the arithmetic processing unit 110 determines whether or not an arithmetic processing method is set (S206). If the arithmetic processing method is set, the arithmetic processing unit 110 applies arithmetic processing to the simulator operation results stored in the operation result storage unit 108 (S207). Next, the display unit 111 displays the simulator operation results stored in the operation result storage unit 108 and/or the arithmetic processing results on a monitor (not shown) or the like (S208).

[Scenario Execution Unit]

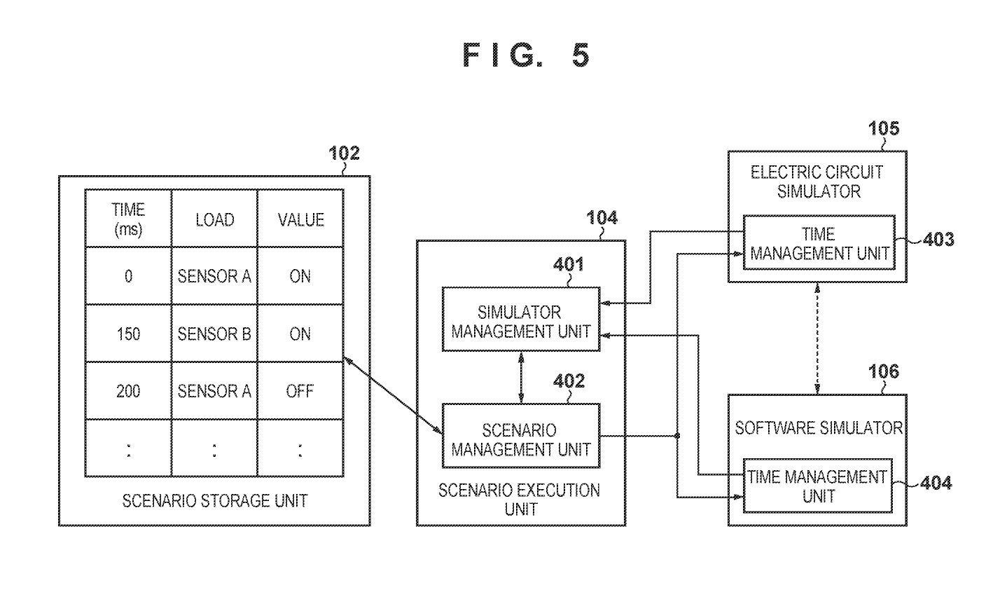

The arrangement of the scenario execution unit 104 will be described below with reference to the block diagram shown in FIG. 5.

FIG. 5 shows the scenario storage unit 102, scenario execution unit 104, electric circuit simulator 105, and software simulator 106, and does not show the scenario selection unit 103. As described above, a simulator operation scenario selected from the scenario storage unit 102 by the scenario selection unit 103 is input to the scenario execution unit 104.

The scenario execution unit 104 includes a simulator management unit 401 and scenario management unit 402. The electric circuit simulator 105 includes a time management unit 403, and the software simulator 106 includes a time management unit 404.

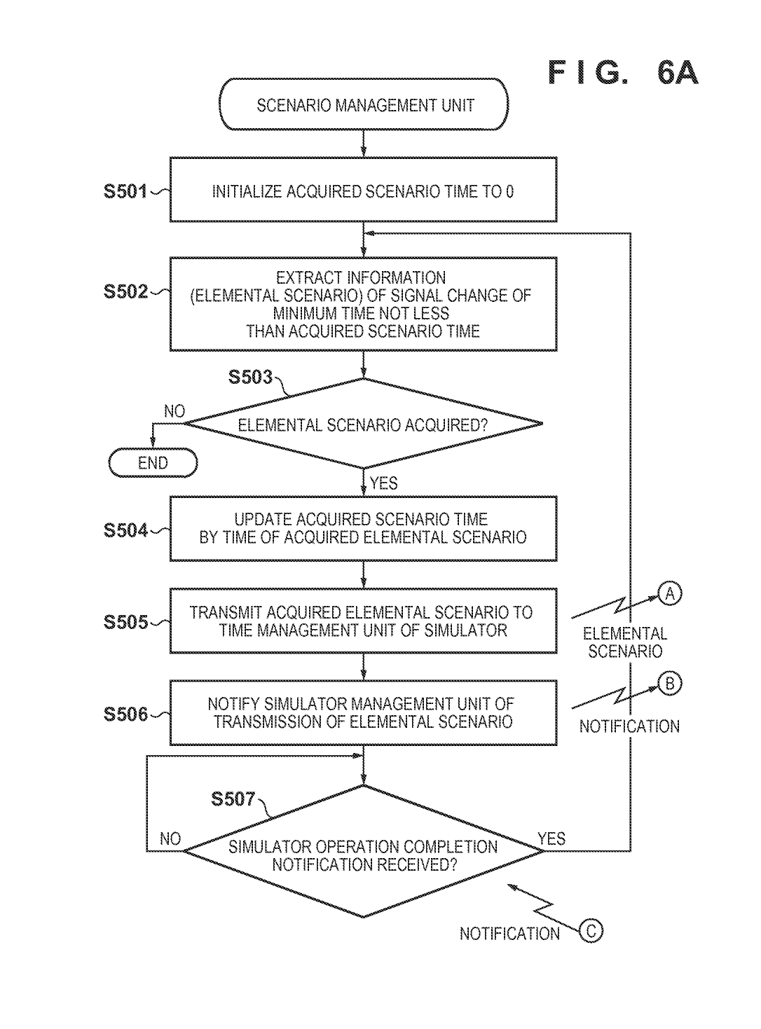

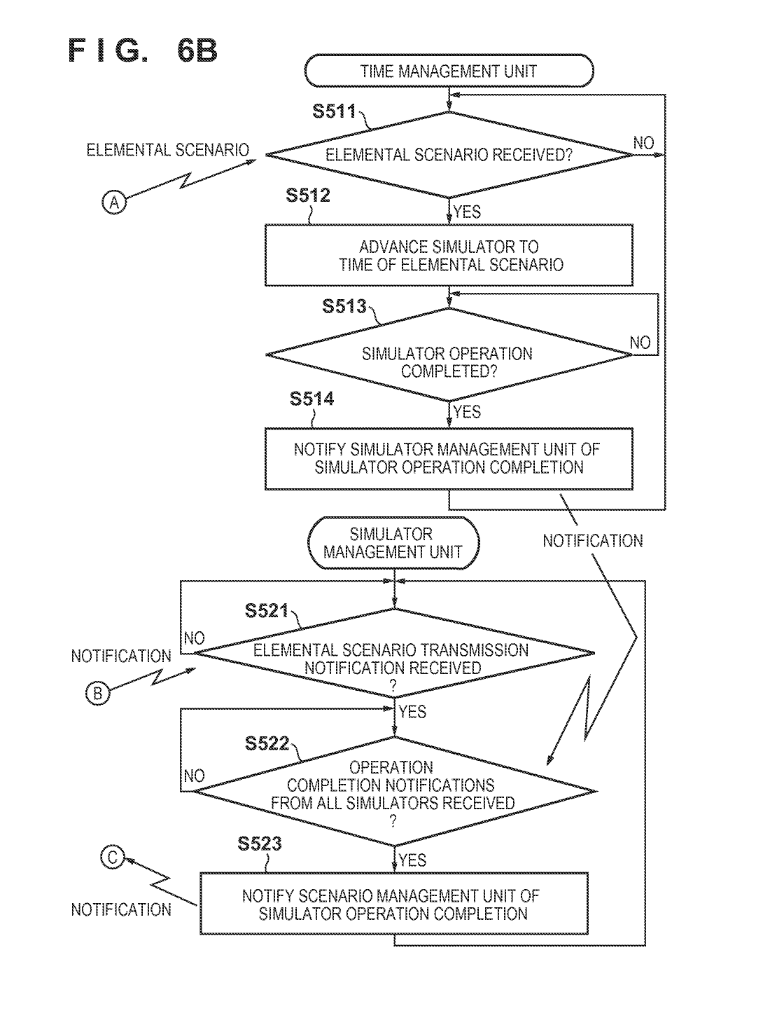

An operation example of the scenario execution unit 104 will be described below with reference to the flowcharts shown in FIGS. 6A and 6B.

The scenario management unit 402 initializes an acquired scenario time t as an internal variable to zero (S501). Then, the scenario management unit 402 extracts a simulator operation scenario having a minimum elapsed time, which is not less than the acquired scenario time t, from the selected simulator operation scenarios stored in the scenario storage unit 102 (S502). That is, the scenario management unit 402 searches the selected simulator operation scenarios for a signal change, the time 1602 in FIG. 2 of which is not less than the acquired scenario time t and is minimum. Then, the scenario management unit 402 acquires information (the signal type 1601, time 1602, signal name 1603, and signal change 1604 shown in FIG. 2) of the signal change as the search result as a simulator operation scenario (to be referred to as “elemental scenario” hereinafter). Note that a plurality of pieces of signal change information may be acquired. Furthermore, a plurality of elemental scenarios may be extracted to include, in addition to the elemental scenario, the second and subsequent elemental scenarios which follow that elemental scenario.

Next, the scenario management unit 402 determines whether or not the elemental scenario is acquired (S503). If no elemental scenario is acquired, the scenario management unit 402 determines that the selected simulator operation scenario is complete, thus ending the processing. If the elemental scenario is acquired, the scenario management unit 402 updates the acquired scenario time by the time 1602 of the elemental scenario (S504).

Next, the scenario management unit 402 transmits the acquired elemental scenario to the time management unit 403 of the electric circuit simulator 105 and the time management unit 404 of the software simulator 106 (S505). Note that if an elemental scenario to be executed by only one simulator is acquired in step S502, the scenario management unit 402 transmits the elemental scenario to only the time management unit of one simulator. Furthermore, the scenario management unit 402 notifies simulator management unit 401 of transmission of the elemental scenario (S506).

Upon reception of the elemental scenario from the scenario management unit 402 (S511), the time management units 403 and 404 advance the simulators up to the time 1602 of the elemental scenario (S512). Then, upon completion of the simulator operations (S513), the time management units 403 and 404 notifies the simulator management unit 401 of the scenario execution unit 104 of completion of the simulator operations (S514), and the process returns to step S511.

The simulator management unit 401 determines whether or not a notification indicating transmission of the elemental scenario (to be referred to as “transmission notification of an elemental scenario” hereinafter) is received from the scenario management unit 402 (S521). Then, upon reception of the transmission notification of the elemental scenario, the simulator management unit 401 determines whether or not completion notifications of simulator operations are received from the time management units (the time management units 403 and 404 in this example) of all the simulators (S522). Then, upon reception of the completion notifications of the simulator operations from the time management units of all the simulators, the simulator management unit 401 notifies the scenario management unit 402 of completion of the simulator operations (S523). Then, the process returns to step S521.

Upon reception of the simulator operation completion notification from the simulator management unit 401 (S507), the process returns to step S502, and the scenario management unit 402 acquires the next elemental scenario.

The scenario execution unit 104 repeats the operations from step S502 to step S507 until the scenario management unit 402 can no longer acquire an elemental scenario from the scenario storage unit 102. The scenario execution unit 104 controls to operate the simulators based on the simulator operation scenario while synchronizing the simulators by the aforementioned time management.

[Input of Arithmetic Processing Method]

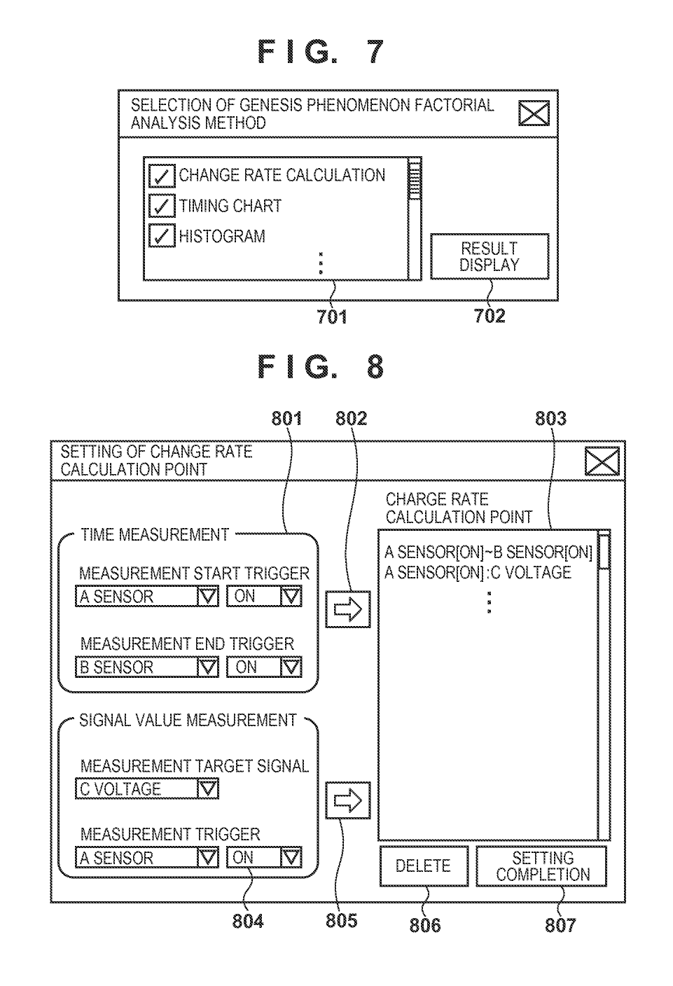

FIG. 7 shows an example of a UI used to input an arithmetic processing method.

The user inputs an arithmetic processing method with reference to a list box 701 of the UI shown in FIG. 7. That is, when the user checks check boxes of factorial analysis methods displayed in the list box 701 to select desired factorial analysis methods, and presses a “result display” button 702 the selected factorial analysis methods are input as arithmetic processing methods. Note that FIG. 7 shows a state in which “change rate calculation”, “timing chart”, and “histogram” are selected as examples of the factorial analysis methods. Also, principal component analysis, cluster analysis, and the like are selectable.

A detailed setting example of the arithmetic processing method will be described below with reference to FIG. 8. Note that FIG. 8 shows a detailed setting example of the change rate calculation.

In the change rate calculation, a point at which a change rate is to be calculated in the simulator operation result (to be referred to as “change rate calculation point” hereinafter) is set. Also, the change rate includes that of a time (time measurement) and that of a signal value (signal value measurement).

The time measurement is to calculate a change rate after an arbitrary signal is set in an arbitrary state (measurement start trigger) until another arbitrary signal is set in an arbitrary state (measurement end trigger). A time measurement field 801 in FIG. 8 shows an example in which “A sensor=ON” is set as the measurement start trigger, and “B sensor=ON” is set as the measurement end trigger.

The signal value measurement is to calculate, when an arbitrary signal is set in a certain state (measurement trigger), a change or change rate of a value of another arbitrary signal (to be referred to as “measurement target signal” hereinafter. A signal measurement field 804 in FIG. 8 shows an example in which “A sensor=ON” is set as the measurement trigger, and “C voltage” is set as the measurement target signal. In this manner, the user can arbitrarily set a point to be observed. The following description will be given taking a change rate as an example. By calculating the change rate, an allowable range of errors or the like can be taken into consideration.

When the user sets respective items in the time measurement field 801 and presses an add button 802, time measurement setting contents are input to a change rate calculation point field 803. Likewise, when the user sets respective items in the signal value measurement field 804 and presses an add button 805, signal value measurement setting contents are input to the change rate calculation point field 803.

Also, when the user selects an unnecessary change rate calculation point listed in the change rate calculation point field 803, and presses a “delete” button 806, that change rate calculation point is deleted from the change rate calculation point field 803. When the user judges that change rate calculation detailed settings are complete, he or she presses a “setting completion” button 807.

Note that the change rate calculation is not limited to the time measurement and signal value measurement. As the measurement trigger of the signal value measurement, for example, a delay time from when an arbitrary signal assumes an arbitrary value until the measurement trigger is reached, a timing at which conditions of a large number of signals are satisfied, and the like can be set. That is, other conditions which can be specified by signal states can be set as the signal value measurement trigger.

[Display of Arithmetic Processing Result]

Display operations of the arithmetic processing results will be explained below taking four examples of arithmetic processing required to execute factorial analysis of a genesis phenomenon. Of course, the arithmetic processing is not limited to these four examples.

Display of Change Rate, SN Ratio, and Sensitivity

A display example of a change rate, SN ratio, and sensitivity (to be also collectively referred as “change rate and the like” hereinafter) of an arbitrary factor with respect to an arbitrary phenomenon will be described below.

For example, assume that a simulator operation scenario when calculation conditions of a change rate and the like are set and a malfunction occurs (to be referred to as “malfunction occurrence scenario” hereinafter) and a simulator operation scenario when no malfunction occurs (to be referred to as “malfunction non-occurrence scenario” hereinafter) are selected. Then, a change rate, SN ratio, and sensitivity are calculated according to the simulator operation results based on these simulator operation scenarios and the calculation conditions of the change rate and the like, and their calculation results (arithmetic processing results) are displayed.

As examples of signals to be verified, “voltage value” at an arbitrary point and “time from an ON timing of a certain sensor until an ON timing of another sensor” are used. Next, with respect to the simulator operation results of the malfunction occurrence scenario and malfunction non-occurrence scenario, values of signals to be verified are extracted. Then, a change rate (%), SN ratio (db), and sensitivity (db) are calculated by:

Change rate: cr=|(m2−m1)×100/m1| (1)

S/N ratio: η=10 log(m²/σ²) (2)

Sensitivity: S=10 log m² (3)

where

m1 is a value extracted from the simulator operation result of the malfunction occurrence scenario,

m2 is a value extracted from the simulator operation result of the malfunction non-occurrence scenario,

m is an average value of the extracted values, and

σ is a standard deviation of the extracted values.

In this embodiment, the case has been exemplified wherein the SN ratio and sensitivity in nominal-the-best characteristics of static characteristics are calculated. However, the present invention is not limited to them. For example, SN ratios and sensitivities in smaller-the-better characteristics, larger-the-better characteristics, and zero-the-best characteristics of static characteristics and a proportional formula and reference point proportional formula of dynamic characteristics can also be calculated.

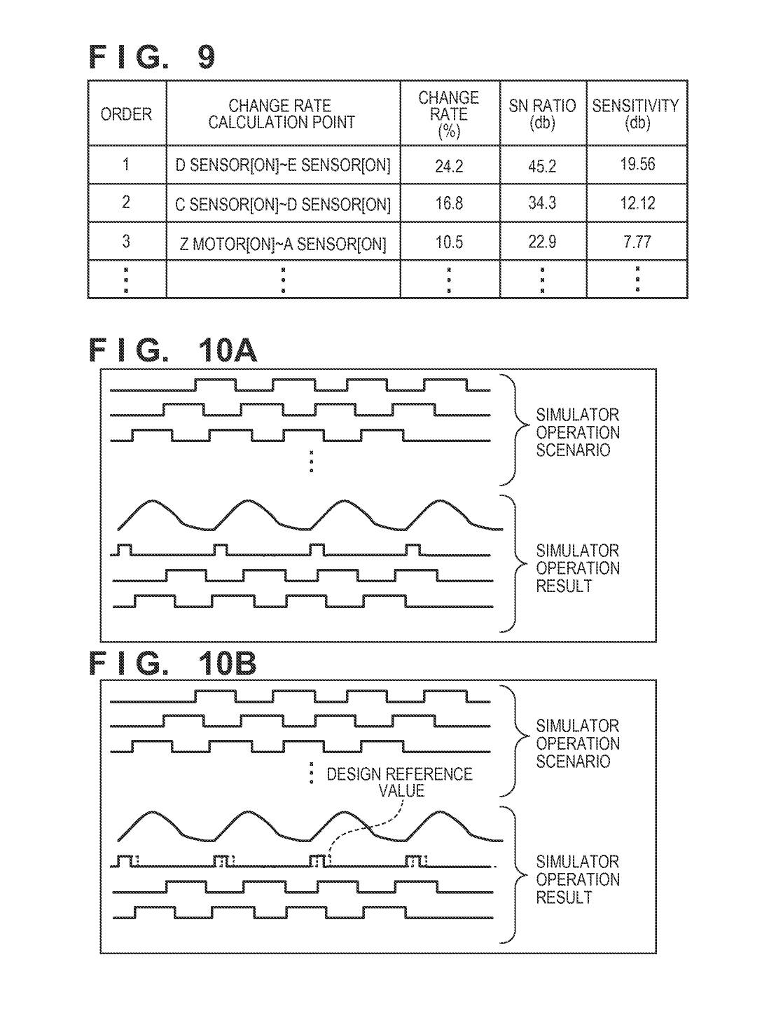

A display example of the change rate and the like will be described below with reference to FIG. 9. Note that FIG. 9 shows a display example, and a display method and items can be changed as needed. FIG. 9 shows a display example of change rate calculation points in a change rate order. That is, the first column indicates a change rate order, the second column indicates a change rate calculation point, and the third to fifth columns respectively indicate a change rate (minimum and maximum change rates when there are a plurality of simulation operation results), SN ratio, and sensitivity.

Display of Timing Chart

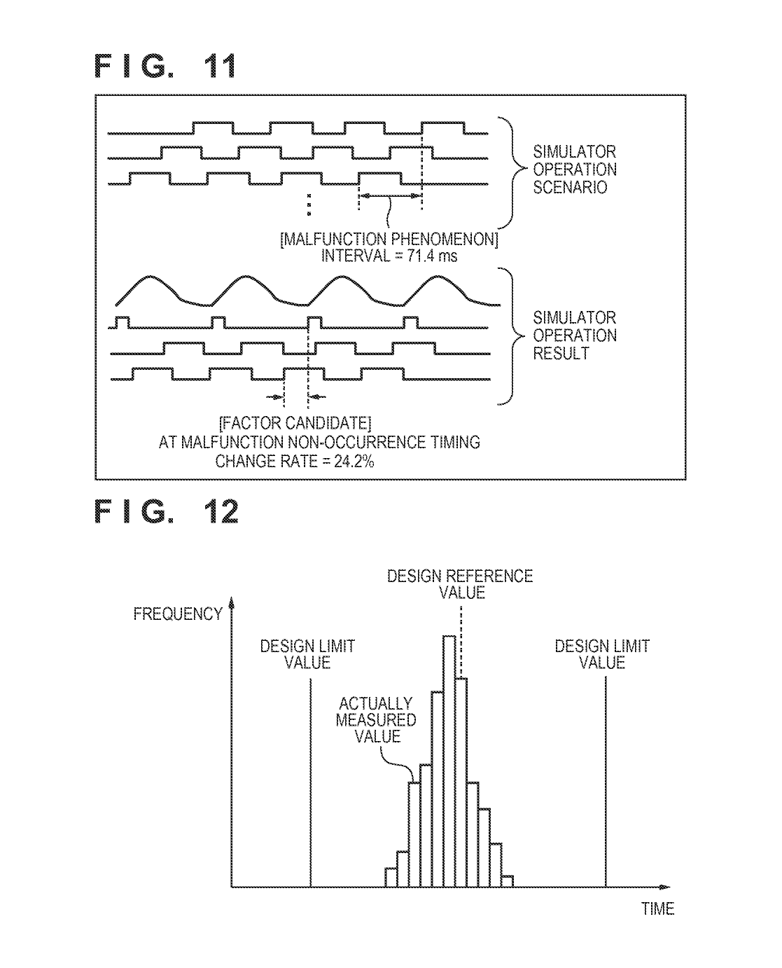

A display example of timing charts in the factorial analysis method of a genesis phenomenon using timing charts will be described below with reference to FIGS. 10A and 10B.

FIG. 10A shows a parallel display example of timing charts corresponding to the simulator operation scenario and those obtained as a simulator operation result. For example, factorial analysis is executed by analyzing shifts of timings and the like such as disturbed waveforms, changes of a rising time and falling time, changes of an ON time or OFF time, and the like in the timing charts of the simulator operation result.

FIG. 10B shows a display example when information effective for factorial analysis such as design reference values is displayed on the timing charts obtained as the simulator operation result.

FIG. 11 shows a display example in which the calculation result of the change rate and timing charts are displayed in cooperation with each other. For example, when the user designates an arbitrary column in the display of the change rate and the like shown in FIG. 9, its factor and phenomenon are displayed on the timing charts, as shown in FIG. 11.

On the timing charts of the simulator operation scenario, a portion corresponding to a “malfunction phenomenon” and its interval are displayed. On the timing charts of the simulator operation result, a portion corresponding to a malfunction occurrence timing and a change rate corresponding to a malfunction non-occurrence timing are displayed as “factor candidates” of a malfunction. Note that the “malfunction phenomenon” and “factor candidate” may be displayed by clearly specifying a highlight or focus movement (not shown) or in combination with arrows, text, and the like.

Histogram Display

A display example of a histogram in the factorial analysis method of a genesis phenomenon using a histogram will be described below with reference to FIG. 12.

The arithmetic processing unit 110 generates a histogram at arbitrary points in association with the simulation operation result. The arbitrary points indicate those in the time measurement and signal value measurement as in calculations of the change rate. Furthermore, information such as a design reference value and design limit value may also be displayed, as shown in FIG. 12. The histogram in FIG. 12 indicates a distribution of actually measured values at arbitrary points. The user judges whether or not the distribution of actually measured values at the arbitrary points sufficiently falls within a design limit range with reference to the histogram shown in FIG. 12, or whether or not that distribution is about to deviate from the design limit range although it falls within the design light range, and uses the judgment result in analysis.

For example, the simulator operations are executed based on a malfunction operation simulator operation scenario and normal operation simulator operation scenario, and their simulator operation results are compared. In this comparison, the arithmetic processing required to execute factorial analysis of a genesis phenomenon is executed, thus efficiently executing factorial analysis of a genesis phenomenon.

Also, when a malfunction has occurred in a production stage of a product, simulator operations are executed using an existing equipment log at the malfunction occurrence timing to confirm operations of an electric circuit and software at that time, thus analyzing occurrence factors of the malfunction. Furthermore, simulator operations are executed using an existing equipment log at the occurrence timing of a malfunction and that at a non-occurrence timing of the malfunction, and arithmetic processing such as a change rate calculation is applied to these simulator operation results, thus allowing easier analysis of occurrence factors of the malfunction.

In this manner, by operating the simulation apparatus which cooperates a plurality of simulators using arbitrary simulator operation scenarios, condition-exhaustive simulation operation results can be obtained. Then, a simulation result corresponding to an arbitrary phenomenon can be obtained without searching these simulator operation results for a simulation result of a corresponding phenomenon. Therefore, a versatile simulator environment can be provided.

### Second Embodiment

A simulation apparatus and its information processing according to the second embodiment of the present invention will be described below. Note that the same reference numerals in the second embodiment denote the same components as those in the first embodiment, and a detailed description thereof will not be repeated.

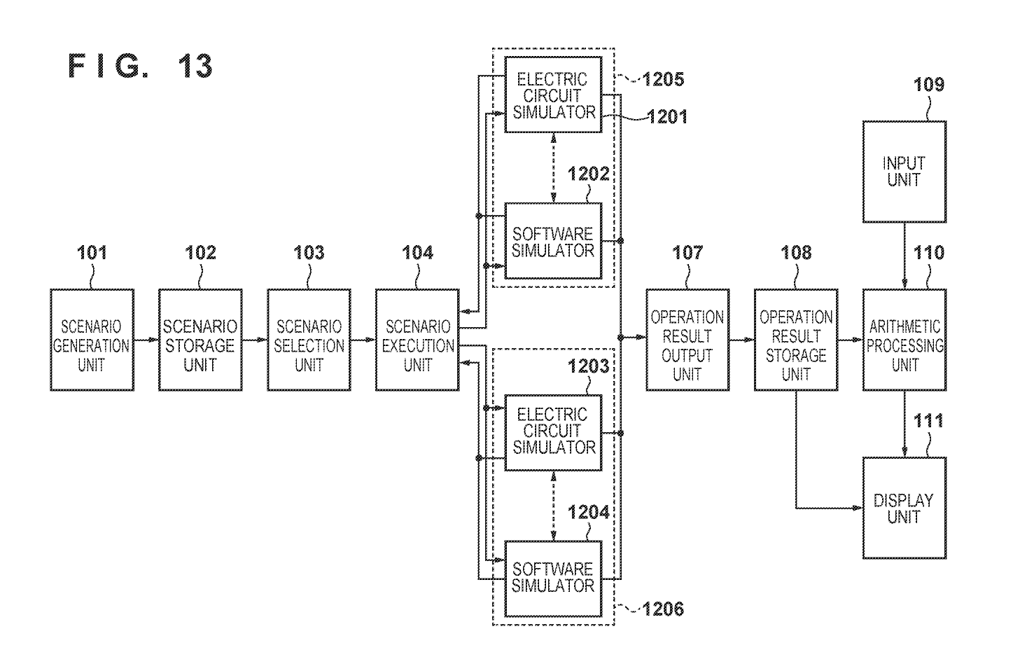

The processing arrangement of a simulation apparatus according to the second embodiment will be described below with reference to the block diagram shown in FIG. 13. The simulation apparatus of the second embodiment includes a simulator (to be referred to as “concatenative simulator” hereinafter) 1205 which cooperates an electric circuit simulator 1201 and software simulator 1202. Furthermore, the apparatus includes a concatenative simulator 1206 which concatenates an electric circuit simulator 1203 and software simulator 1204. That is, unlike in the simulation apparatus of the first embodiment, which includes one set of concatenative simulators, the simulation apparatus of the second embodiment includes two sets of concatenative simulators.

A cooperation between the simulators which configure each concatenative simulator is indispensable, but that between simulators which configure different concatenative simulators is not indispensable. Hence, a cooperation between simulators is not a limiting condition.

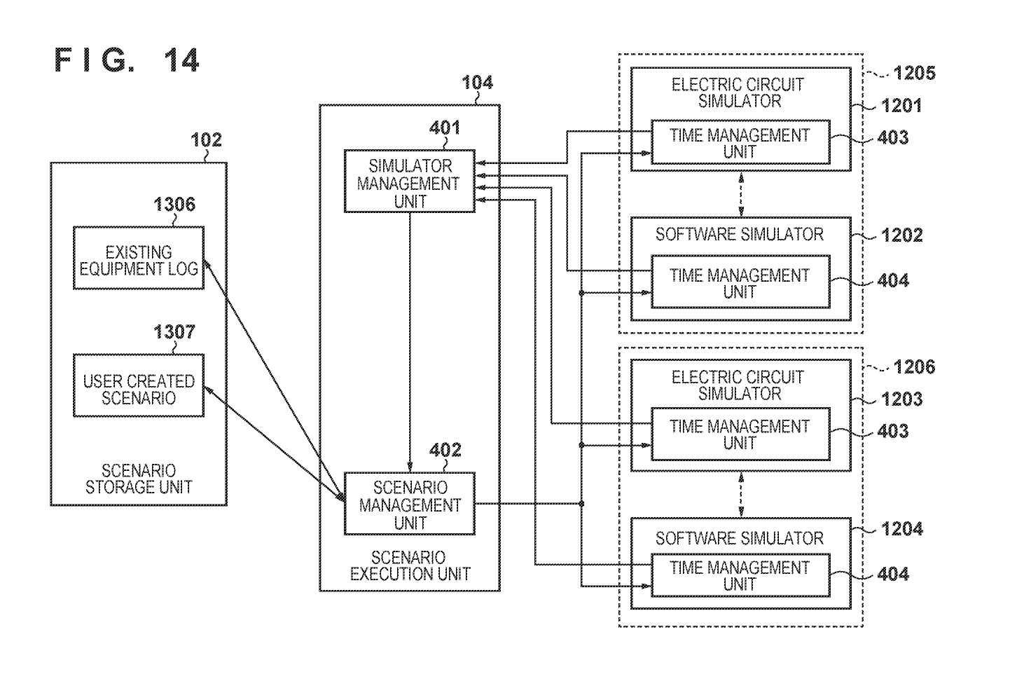

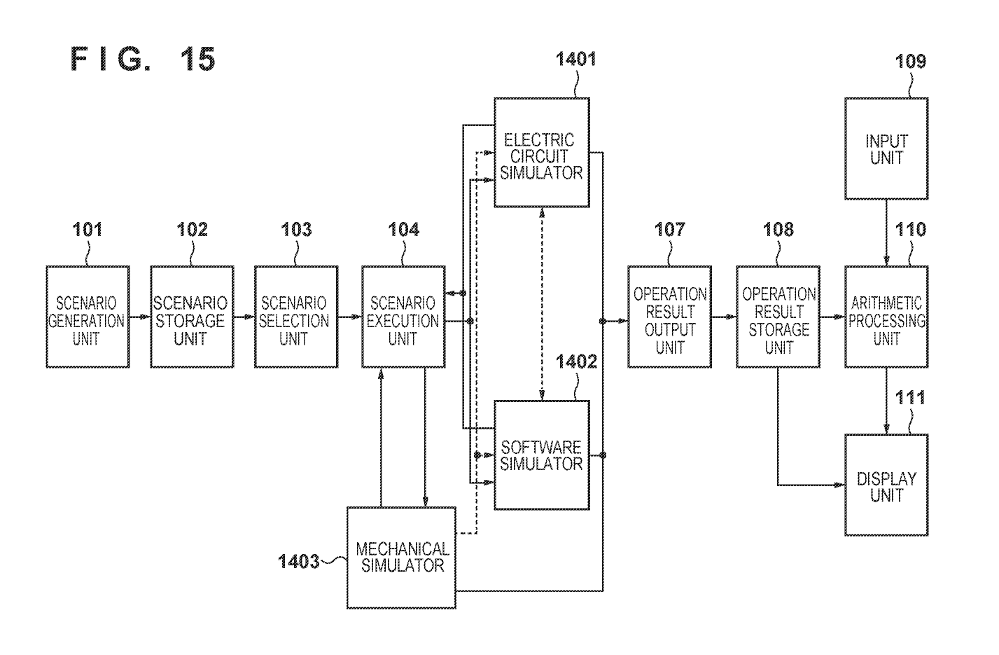

The arrangement of a scenario execution unit 104 according to the second embodiment will be described below with reference to the block diagram shown in FIG. 14. Unlike in the first embodiment, as simulator operation scenarios required for the scenario execution unit 104 to operate the two sets of concatenative simulators 1205 and 1206, two scenarios, that is, an existing equipment log 1306 and user created scenario 1307 are prepared.

An operation of the simulation apparatus will be described below using a practical example. Note that a case will be exemplified below wherein upon development of a copying machine, a copying machine itself is available as an existing equipment, and an existing equipment log is also available, but an existing equipment of a coupled device such as a finisher is not available.

The electric circuit simulator 1201 incorporates an electric circuit model of the copying machine, and the software simulator 1202 incorporates product software of the copying machine. The concatenative simulator 1205 executes a simulator operation according to the existing equipment log 1306.

On the other hand, the electric circuit simulator 1203 incorporates an electric circuit model of the finisher, and the software simulator 1204 incorporates software of the finisher. The concatenative simulator 1206 executes a simulator operation according to the user created scenario 1307 (for example, design specifications).

A scenario management unit 402 of the scenario execution unit 104 judges which simulator operation scenario is to be input to which simulator. Also, all the simulators are operated in synchronism with each other as in the first embodiment.

For example, when an existing equipment log of a common portion such as a cooperation between the copying machine and finisher is available, the existing equipment logs may be input to the concatenative simulator of the copying machine, and the existing equipment log and user created scenario may be input to the concatenative simulator of the finisher. Of course, a combination of the plurality of simulators and scenarios is not limited to the aforementioned combination, and simulator operation scenarios are not limited to the existing equipment logs and user created scenario.

In this manner, when a plurality of cooperative systems of a plurality of simulators are available, each of the cooperative systems of the plurality of simulators can be operated using arbitrary simulator operation scenarios. Thus, even when the plurality of cooperative systems of the plurality of simulators are available, condition-exhaustive simulator operations can be obtained. Then, a simulation result corresponding to an arbitrary phenomenon can be obtained without searching these simulator operation results for a simulation result of a corresponding phenomenon.

### Third Embodiment

A simulation apparatus and its information processing according to the third embodiment of the present invention will be described below. Note that the same reference numerals in the third embodiment denote the same components as those in the first embodiment, and a detailed description thereof will not be repeated.

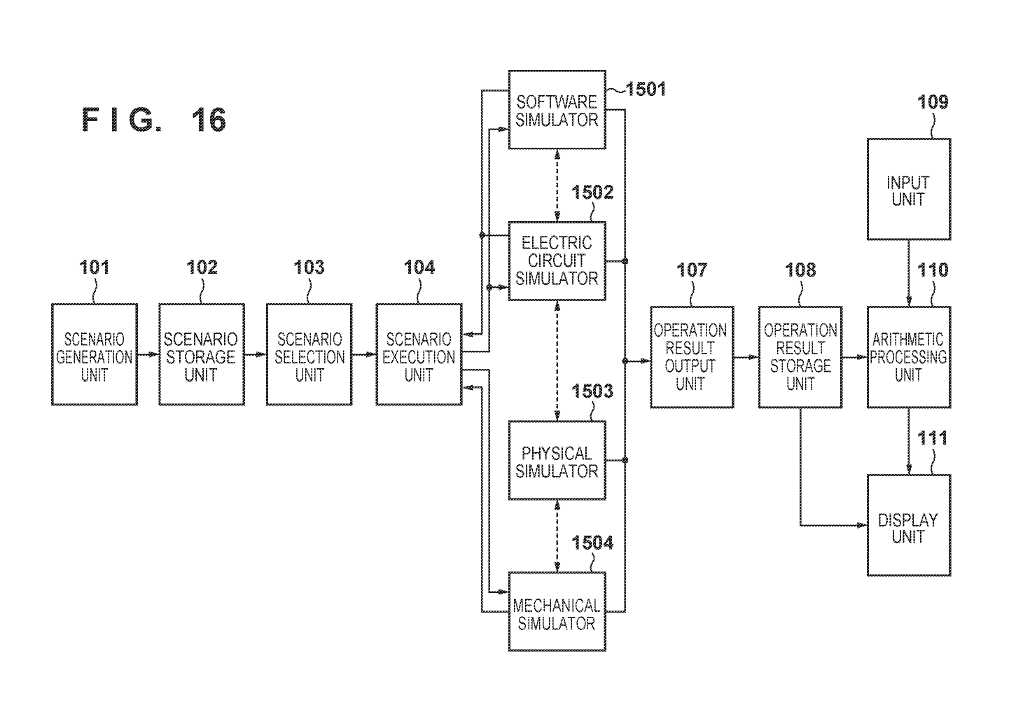

The processing arrangement of a simulation apparatus according to the third embodiment will be described below with reference to the block diagram shown in FIG. 15. The simulation apparatus according to the third embodiment includes a concatenative simulator which cooperates an electric circuit simulator 1401 and software simulator 1402.

The simulation apparatus further includes a mechanical simulator 1403, which simulates operations of a mechanical mechanism and mechanical components. The mechanical simulator 1403 is respectively cooperated with the electric circuit simulator 1401 and software simulator 1402. Therefore, the simulator operations of the electric circuit simulator 1401 and software simulator 1402 are in a cooperation state which is influenced not only by simulator operation scenarios input from a scenario execution unit 104 but also partially by the operation of the mechanical simulator 1403.

An operation of the simulation apparatus will be described below using a practical example. Note that development of a print sheet conveyance sequence of a copying machine will be explained as an example.

A scenario management unit 402 of the scenario execution unit 104 inputs simulator operation scenarios having information of movements of print sheets to the electric circuit simulator 1401 and software simulator 1402 to control these simulators to execute print sheet conveyance simulator operations. In this case, the mechanical simulator 1403 operates in synchronism with the operations of the electric circuit simulator 1401 and software simulator 1402.

For example, when a state change, for example, an out of print sheets, has occurred in the simulator operation of the mechanical simulator 1403, the mechanical simulator 1403 notifies the electric circuit simulator 1401 and software simulator 1402 of that information. This notification influences the electric circuit simulator 1401 and software simulator 1402. The electric circuit simulator 1401 and software simulator 1402 stop, for example, the print sheet conveyance simulation operations, and start simulation operations when print sheets are absent.

### Fourth Embodiment

A simulation apparatus and its information processing according to the fourth embodiment of the present invention will be described below. Note that the same reference numerals in the fourth embodiment denote the same components as those in the first embodiment, and a detailed description thereof will not be repeated.

The processing arrangement of a simulation apparatus according to the fourth embodiment will be described below with reference to the block diagram shown in FIG. 16. The simulation apparatus according to the fourth embodiment includes a software simulator 1501, electric circuit simulator 1502, physical simulator 1503, and mechanical simulator 1504.

The software simulator 1501 and electric circuit simulator 1502 are cooperated with each other, the electric circuit simulator 1502 and physical simulator 1503 are cooperated with each other, and the physical simulator 1503 and mechanical simulator 1504 are cooperated with each other.

For example, the software simulator 1501 is not directly cooperated with the physical simulator 1503, but is influenced by the operation of the physical simulator 1503 via the electric circuit simulator 1502. In other words, the software simulator 1501 and physical simulator 1503 are indirectly cooperated with each other. The relationship between the software simulator 1501 and mechanical simulator 1504 and that between the electric circuit simulator 1502 and mechanical simulator 1504 are also indirect cooperations.

The physical simulator 1503 simulates physical phenomena such as a thermal fluid, noise, and vibrations on software. The description of the fourth embodiment will be given under the assumption that the physical simulator 1503 is a thermal fluid simulator. For example, the physical simulator 1503 simulates a thermal fluid based on a heat value of an electric circuit simulated by the electric circuit simulator 1502 and an operation of a fan simulated by the mechanical simulator 1504. Thus, heat states (a temperature rise and temperature distribution) in a product can be simulated in consideration of the operations of the electric circuit and mechanical mechanism.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-170380 filed Jul. 31, 2012 which is hereby incorporated by reference herein in its entirety.

What is claimed is:

1. An information processing apparatus comprising:
a plurality of simulators which are configured to be directly or indirectly cooperated;
a storage unit configured to store simulator operation scenarios having time information; and
an execution unit configured to extract an elemental scenario as an element of the simulator operation scenario from the simulator operation scenario, to transmit the elemental scenario to at least one of the plurality of simulators which are cooperated, to synchronize the plurality of simulators, and to control the plurality of simulators to execute simulator operations.

2. The apparatus according to claim 1, further comprising a selection unit operable to select a simulator operation scenario to be executed by the execution unit from the stored simulator operation scenarios.

3. The apparatus according to claim 1, wherein the execution unit comprises:
a scenario management unit configured to extract and transmit the elemental scenario; and
a simulator management unit configured to synchronize the plurality of simulators.

4. The apparatus according to claim 3, wherein the scenario management unit transmits a transmission notification to the simulator management unit after transmission of the elemental scenario,
wherein, after reception of the transmission notification, in a case where the simulator management unit receives end notifications of simulator operations from all the simulators to which the elemental scenario is transmitted, the simulator management unit transmits the end notifications to the scenario management unit, and
wherein, after reception of the end notifications, the scenario management unit extracts and transmits a next elemental scenario.

5. The apparatus according to claim 3, wherein the scenario management unit initializes an acquired scenario time at the beginning of extraction of the elemental scenario, and updates the acquired scenario time by time information of the elemental scenario extracted from the simulator operation scenario.

6. The apparatus according to claim 2, wherein a plurality of simulator operation scenarios can be selected by the selection unit, and
the execution unit controls a plurality of simulators which are cooperated or a plurality of simulators which are not cooperated to execute simulator operations respectively based on the plurality of selected simulator operation scenarios.

7. The apparatus according to claim 1, further comprising a result storage unit configured to store simulator operation results of the plurality of simulators.

8. The apparatus according to claim 7, further comprising an input unit configured to input arithmetic processing to be applied to the simulator operation results for factorial analysis of a genesis phenomenon.

9. The apparatus according to claim 8, further comprising:
an arithmetic processing unit configured to apply the arithmetic processing to the simulator operation results stored in the result storage unit; and
a display unit configured to display at least one of the simulator operation results stored in the result storage unit and results of the arithmetic processing.

10. The apparatus according to claim 1, further comprising a generation unit configured to generate the simulator operation scenario from an operation result of an apparatus.

11. The apparatus according to claim 1, wherein the simulator comprises at least two of an electric circuit simulator, a software simulator, a mechanical mechanism simulator, and a physical phenomenon simulator.

12. The apparatus according to claim 3, wherein the scenario management unit extracts a plurality of elemental scenarios.

13. The apparatus according to claim 12, wherein the scenario management unit extracts an elemental scenario which follows the elemental scenario in addition to the elemental scenario.

14. The apparatus according to claim 1, wherein the execution unit extracts, from the simulator operation scenario, a simulator operation scenario where the time information indicates a minimum time as the elemental scenario.

15. An information processing method for an information processing apparatus having a plurality of simulators which are configured to be directly or indirectly cooperated, the method comprising:
using a processor to perform the steps of:
storing simulator operation scenarios having time information;
extracting an elemental scenario as an element of the simulator operation scenario from the simulator operation scenario;
transmitting the elemental scenario to at least one of the plurality of simulators which are cooperated;
synchronizing the plurality of simulators; and
controlling the plurality of simulators to execute simulator operations.

16. A non-transitory computer readable medium storing program for causing a computer to perform the method according to claim 15.
